(19) United States
(12) Patent Application Publication
(10) Pub. No.: US 2026/0056553 A1
(43) Pub. Date: Feb. 26, 2026

(54) ROUGH APPROACH AND PRECISE CONTROL OF VEHICLE POSITION

(71) Applicant: Deere & Company, Moline, IL (US)

(72) Inventors: Riley J. Wegmann, Urbana, IA (US); William J. Vande Haar, Janesville, IA (US); Shane M. Boden, Vinton, IA (US)

(21) Appl. No.: 18/593,137

(22) Filed: Mar. 1, 2024

(51) Int. Cl. G05D 1/646; A01D 90/16; G05D 1/246; G05D 1/249; G05D 1/667; G05D 105/20; G05D 107/20; G05D 109/10; G05D 111/30

(52) U.S. Cl. CPC G05D 1/646; A01D 90/16; G05D 1/246; G05D 1/249; G05D 1/667; G05D 2105/20; G05D 2107/21; G05D 2109/10; G05D 2111/32

(57) ABSTRACT

A navigation control system on a material transfer vehicle includes a rough approach location system that identifies a rough location of a destination of the material transfer vehicle in order to perform an unloading operation. The rough location is provided to a path planning system which generates a path that the material transfer vehicle follows to the rough location. As the material transfer vehicle approaches the rough location, a set of on-board sensors sense a more precise location of a container that is to receive the material from the material transfer vehicle. The more precise location is provided to the path planning system which modifies the path based upon the more precise location. As the material transfer vehicle comes closer to the container, the precise approach system corrects the precise location of the container and provides the corrected precise location to the path planning system. The path planning system continues to correct the path based upon the additional precise container locations. A navigation system navigates the material transfer vehicle along the path generated by the path planning system.

### FIELD OF THE DESCRIPTION

The present description relates to automatically controlling vehicle operation as vehicles approach one another. More specifically, the present description relates to performing rough approach control when vehicles are separated from one another by a first distance and performing more precise control as the vehicles approach one another.

### BACKGROUND

There are many different types of mobile work machines. Some such work machines include agricultural machines, construction machines, forestry machines, etc. In order to perform work operations, it is not uncommon that two work machines must approach one another and come into a pre-defined location relative to one another.

For instance, during a harvesting operation, a material transfer vehicle (such as a tractor-pulled grain cart) may receive harvested material from a harvester and then transfer that material back to a container which resides in an unloading zone. The container may include a haulage vehicle (such as a semi-trailer, or other vehicle) or another type of container. The material transfer vehicle approaches the container and then pulls alongside the container to unload the harvested material into the container.

In another example, an excavator may excavate material from a worksite. A dump truck may approach the excavator and pull into a predefined spatial relationship relative to the excavator, so the excavator can load material into the dump truck.

These are just two of a wide variety of different examples where two mobile work machines must be located closely proximate one another in order to perform a desired operation.

The discussion above is merely provided for general background information and is not intended to be used as an aid in determining the scope of the claimed subject matter.

### SUMMARY

A navigation control system on a material transfer vehicle includes a rough approach location system that identifies a rough location of a destination of the material transfer vehicle in order to perform an unloading operation. The rough location is provided to a path planning system which generates a path that the material transfer vehicle follows to the rough location. As the material transfer vehicle approaches the rough location, a set of on-board sensors sense a more precise location of a container that is to receive the material from the material transfer vehicle. The more precise location is provided to the path planning system which modifies the path based upon the more precise location. As the material transfer vehicle comes closer to the container, the precise approach system corrects the precise location of the container and provides the corrected precise location to the path planning system. The path planning system continues to correct the path based upon the additional precise container locations. A navigation system navigates the material transfer vehicle along the path generated by the path planning system.

Example 1 is a computer implemented method of controlling a material transfer vehicle in approaching a material container, comprising:
receiving a rough location signal from a first sensor;
identifying a rough approach location based on the rough location signal;
generating a navigation path based on the rough approach location;
controlling the material transfer vehicle to travel along the navigation path toward the rough approach location;
detecting a precise approach location based on a location signal from a second sensor, the location signal from the second sensor being indicative of a sensed location of a material container;
identifying a confidence value corresponding to the precise approach location; and
correcting the navigation path based on the precise approach location and based on the confidence level corresponding to the precise approach location.

Example 2 is the computer implemented method of any or all previous examples wherein correcting the navigation path comprises:
comparing the confidence level to a first threshold confidence level to generate a first comparison result.

Example 3 is the computer implemented method of any or all previous examples wherein correcting the navigation path comprises:
determining whether to correct the navigation path based on the first comparison result.

Example 4 is the computer implemented method of any or all previous examples wherein correcting the navigation path comprises:
if it is determined that the navigation path is to be corrected based on the first comparison result, then correcting the navigation path based on the precise approach location.

Example 5 is the computer implemented method of any or all previous examples wherein correcting the navigation path comprises:
comparing the confidence level to a second threshold confidence level to generate a second comparison result.

Example 6 is the computer implemented method of any or all previous examples wherein correcting the navigation path comprises:
determining whether to continue correcting the navigation path based on the second comparison result.

Example 7 is the computer implemented method of any or all previous examples wherein correcting the navigation path comprises:
if it is determined that the navigation path is to continue to be corrected, then repeating the steps of detecting the precise approach location, and correcting the navigation path based on the precise approach location.

Example 8 is the computer implemented method of any or all previous examples wherein the material container comprises a haulage vehicle and wherein detecting a precise approach location comprises:
controlling the material transfer vehicle to travel along the navigation path to reach the rough approach location;
after reaching the rough approach location, waiting until the haulage vehicle is detected with the second sensor; and
detecting the precise approach location based on the sensor signal from the second sensor.

Example 9 is the computer implemented method of any or all previous examples wherein the first sensor comprises a location sensor on a haulage vehicle and wherein obtaining the rough approach location comprises:
receiving a location signal from the first sensor on the haulage vehicle.

Example 10 is the computer implemented method of any or all previous examples wherein obtaining the rough approach location comprises:
accessing map information from a map; and
identifying, as the rough approach location, an unloading area based on the map information.

Example 11 is the computer implemented method of any or all previous examples wherein obtaining the rough approach location comprises:
navigating the material transfer vehicle to the rough approach location; and
after the material transfer vehicle reaches the rough approach location, detecting an operator input saving a current location of the material transfer vehicle as the rough approach location.

Example 12 is an agricultural system, comprising:
a rough approach location system configured to receive a rough location signal from a first sensor system and identify a rough approach location based on the rough location signal;
a path planning system configured to generate a navigation path based on the rough approach location;
a navigation system configured to control the material transfer vehicle to travel along the navigation path toward the rough approach location;
a precise approach location system configured to detect a precise approach location based on a location signal from a second sensor, the location signal from the second sensor being indicative of a sensed location of a material container; and
a confidence level detector configured to identify an accuracy measure indicative of a confidence corresponding to the precise approach location, the path planning system being configured to correct the navigation path based on the precise approach location and based on the accuracy measure.

Example 13 is the agricultural system of any or all previous examples wherein the confidence level detector is configured to compare the confidence level to a first threshold confidence level to generate a first comparison result and determine whether to correct the navigation path based on the first comparison result.

Example 8 is the agricultural system of any or all previous examples wherein the path planning system is configured to correct the navigation path based on the precise approach location when the first comparison result indicates that the accuracy measure meets the first confidence threshold.

Example 15 is the agricultural system of any or all previous examples wherein the material container comprises a haulage vehicle and wherein the navigation system is configured to control the material transfer vehicle to travel along the navigation path to reach the rough approach location and, after reaching the rough approach location, wait until the haulage vehicle is detected with the second sensor wherein the precise approach location is configured to detect the precise approach location based on the sensor signal from the second sensor.

Example 16 is the agricultural system of any or all previous examples wherein the first sensor system comprises a location sensor on a haulage vehicle and wherein the rough approach location system comprises:
a communication system configured to receive a location identifier identifying a location of the haulage vehicle based on a sensor signal from the first sensor system on the haulage vehicle.

Example 17 is the agricultural system of any or all previous examples wherein the first sensor system comprises a map and wherein the rough approach location system comprises:
a map interaction system configured to interact with the map and identify, as the rough approach location, an unloading area based on the map information.

Example 18 is a computer system comprising:
at least one processor; and
a data store storing computer executable instructions which, when executed by the at least one processor, cause the at least one processor to perform steps, comprising:
receiving a rough location signal from a first sensor;
identifying a rough approach location based on the rough location signal;
generating a navigation path based on the rough approach location;
controlling the material transfer vehicle to travel along the navigation path toward the rough approach location;
detecting a precise approach location based on a location signal from a second sensor, the location signal from the second sensor being indicative of a sensed location of a material container;
identifying a confidence value corresponding to the precise approach location; and
correcting the navigation path based on the precise approach location and based on the confidence level corresponding to the precise approach location.

Example 19 is the computer system of any or all previous examples wherein correcting the navigation path comprises:
comparing the confidence level to a first threshold confidence level to generate a first comparison result; and
determining whether to correct the navigation path based on the first comparison result.

Example 20 is the computer system of any or all previous examples wherein the material container comprises a haulage vehicle and wherein detecting a precise approach location comprises:
controlling the material transfer vehicle to travel along the navigation path to reach the rough approach location;
after reaching the rough approach location, controlling the material transfer vehicle to wait until the haulage vehicle is detected with the second sensor; and
detecting the precise approach location based on the sensor signal from the second sensor.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a pictorial illustration of one example of an agricultural system.

FIG. 2 shows the agricultural system illustrated in FIG. 1, with a material transfer vehicle approaching a container location.

FIG. 3 is a block diagram showing one example of a material transfer vehicle.

FIGS. 4A and 4B (collectively referred to herein as FIG. 4) show one example of a flow diagram illustrating the operation of a navigation control system.

FIG. 5 illustrates operation of a navigation control system in controlling a material transfer vehicle to move to a pre-defined position, as a rough approach location.

FIG. 6 is a pictorial illustration showing one example of the navigation control system controlling a material transfer vehicle to approach a pre-defined unloading area, as the rough approach location.

FIG. 7 is a pictorial illustration illustrating one example of the navigation control system controlling the material transfer vehicle to wait adjacent a pre-defined unloading area for a container to become visible to the sensors.

FIG. 8 is a pictorial illustration showing one example of the navigation control system controlling the material transfer vehicle to identify a container and calculate a precise container location.

FIGS. 9, 10, 11, 12, 13, 14, 15, 16, 17, and 18 are pictorial illustrations showing how the navigation control system controls a material transfer vehicle from a point where the container is out of view of the sensors on board the material transfer vehicle up to a point where an unloading operation is complete.

FIGS. 19, 20, 21, and 22 show examples of using fiducial markers to locate a container or haulage vehicle.

FIG. 23 is a block diagram showing one example of the agricultural system illustrated in previous figures, deployed in a remote server environment.

FIGS. 24, 25, and 26 show examples of mobile devices that can be used in the different architectures and systems illustrated herein.

FIG. 27 is a block diagram of one example of a computing environment that can be used in the architectures and systems illustrated herein.

### DETAILED DESCRIPTION

As discussed above, it is not uncommon in many types of work operations (e.g., agricultural operations, construction operations, forestry operations, etc.) for work vehicles to approach one another and come into close proximity to one another in order to perform an operation. This can be done in a variety of different ways. For instance, if both vehicles have high precision global navigation satellite system (GNSS) receivers and communication systems, then the vehicles can communicate their precise locations, to one another so that a navigation system on one or both of the vehicles can use those precise locations to perform path planning in order to bring the two vehicles into a desired location relative to one another to perform the desired operation. However, this can be expensive in that both vehicles need the high precision GNSS systems.

In other scenarios, at least one of the vehicles may have one or more sensors (such as optical sensors, RADAR sensors, LIDAR sensors, ultrasonic sensors, etc.) disposed thereon. Those sensors, once they are within a sensor range, can sense the other vehicle and provide a relatively precise indication of the location and orientation or pose of the other vehicle. Thus, those sensor signals can be used by a path planning and navigation system to plan a path to the other vehicle and to navigate along that path. This type of system also has drawbacks.

For instance, many such sensors have a limited range of perception. Optical sensors, for instance, may have a relatively limited field of view. Other sensors may have a limited sensor range as well. Therefore, the sensor signals that are generated when the other vehicle is at the limit of the sensor range, or outside the sensor range, may be imprecise or have a relatively low confidence value. However, often, as the two vehicles come closer, the confidence level associated with the sensor signals increases and, when the two vehicles are close enough, the confidence level of the sensor signals is high and the location of the other vehicle derived from those sensor signals is relatively precise.

The present description thus describes a system where a first vehicle (e.g., a material transfer vehicle) is approaching a material container (such as a haulage vehicle). This material transfer vehicle uses a rough location sensor (such as a relatively low precision GNSS system) to sense a rough destination location and a path planning system plans a rough path to that destination location. A navigation system begins navigating the material transfer vehicle along the rough path. As the material transfer vehicle approaches the haulage vehicle or container, and comes within a desired sensor range of the haulage vehicle or container, then a set of one or more sensors on the material transfer vehicle generate sensor signals indicative of a more precise destination location (e.g., a more precise location of the haulage vehicle). The path planning system corrects the path based upon the more precise location and the navigation system navigates the material transfer vehicle along the corrected path. The one or more sensors continue to sense the location of the haulage vehicle or material container, with higher precision, as the material transfer vehicle gets closer to the haulage vehicle or container, and the path planning system continues to correct the path as the higher precision destination location is identified, until a threshold precision or confidence level is reached. The navigation system continues to navigate the material transfer vehicle along the calculated path to perform a work operation (such as an unloading operation, etc.).

The present discussion thus uses a relatively imprecise sensor system to generate a rough approach location and then uses more high precision sensors to generate a more precise location as the two vehicles come into closer proximity relative to one another.

It should also be noted that the present description could proceed with respect to any of a wide variety of different scenarios. The present description proceeds with respect to an agricultural system where a material transfer vehicle transfers material from a harvester to a haulage vehicle or other container. However, the present description could just as easily proceed with respect to a material transfer vehicle approaching an excavator to receive material to be transferred, or a truck that approaches a logging vehicle to receive a load of logs for transfer. The description of the present system, deployed in an agricultural system, is given by way of example only.

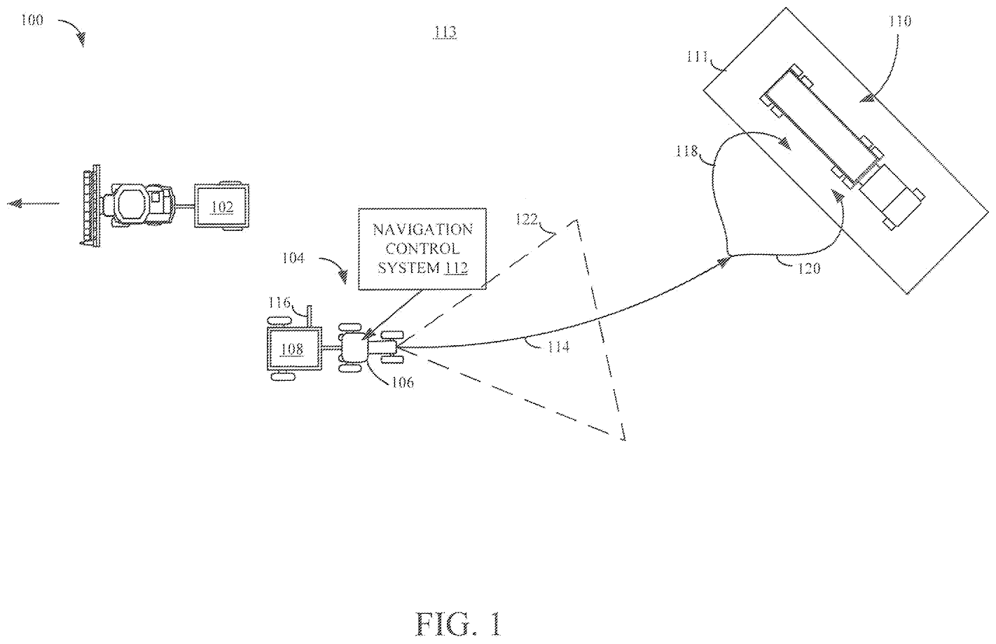

FIG. 1 is a pictorial illustration of one example of an agricultural system 100. Agricultural system 100 includes harvester 102, material transfer vehicle 104 (which includes tractor 106 pulling grain cart 108) and a material container or haulage vehicle 110, which is a semi-tractor pulling a semi-trailer (hereinafter simply referred to has haulage vehicle 110 although another container could be used as well). In the example shown in FIG. 1, material transfer vehicle 104 includes (or has access to) a navigation control system 112.

Material transfer vehicle 104 may receive harvested material from harvester 102. Material transfer vehicle 104 may then transfer that material by driving to a container (such as haulage vehicle 110) and unloading the material from grain cart 108 into haulage vehicle 110. Therefore, once material transfer vehicle 104 leaves harvester 102, navigation control system 112 illustratively plans a path back to haulage vehicle 110 to perform the unloading operation.

Navigation control system 112 may receive a rough location corresponding to haulage vehicle 110 when material transfer vehicle 104 is still a long ways off from haulage vehicle 110 and out of the sensor range 122 of sensors on board material transfer vehicle 104. Thus, navigation control system 112 may generate a rough path 114 toward haulage vehicle 110.

As one example, haulage vehicle 110 may have a relatively low precision GNSS receiver that provides navigation control system 112 with a rough or imprecise location of haulage vehicle 110. In another example, as described in greater detail below, navigation control system 112 may be provided with an indication of the location of an unload area 111 in field 113. The location of unload area 111 may be defined on a map that is loaded into navigation control system 112, be input by an operator or other user, or be provided in other ways. The location of unload area 111 may be used as the rough location for navigation control system 112 to calculate the rough path 114.

However, as material transfer vehicle 104 gets closer to haulage vehicle 110, then more high precision sensors on material transfer vehicle 104 can sense a more precise location and orientation or pose of haulage vehicle 110. In that case, navigation control system 110 can correct the path based upon the more precise location of haulage vehicle 110.

In the example shown in FIG. 1, for instance, it may be that the rough path generated by navigation control system 112 may include the path 114 and path 120. However, material transfer vehicle 104 may have an unloading spout 116 that is deployed off one side of grain cart 108. Therefore, as material transfer vehicle 104 gets closer to haulage vehicle 110, the higher precision sensors may identify the pose of haulage vehicle 110 as that shown in FIG. 1 so that navigation control system 112 corrects the path to follow branch 118. In that way, material transfer vehicle 104 will be positioned alongside haulage vehicle 110, given the location of spout 116 on grain cart 108, so that an unload operation can be performed to transfer material from grain cart 108 into haulage vehicle 110.

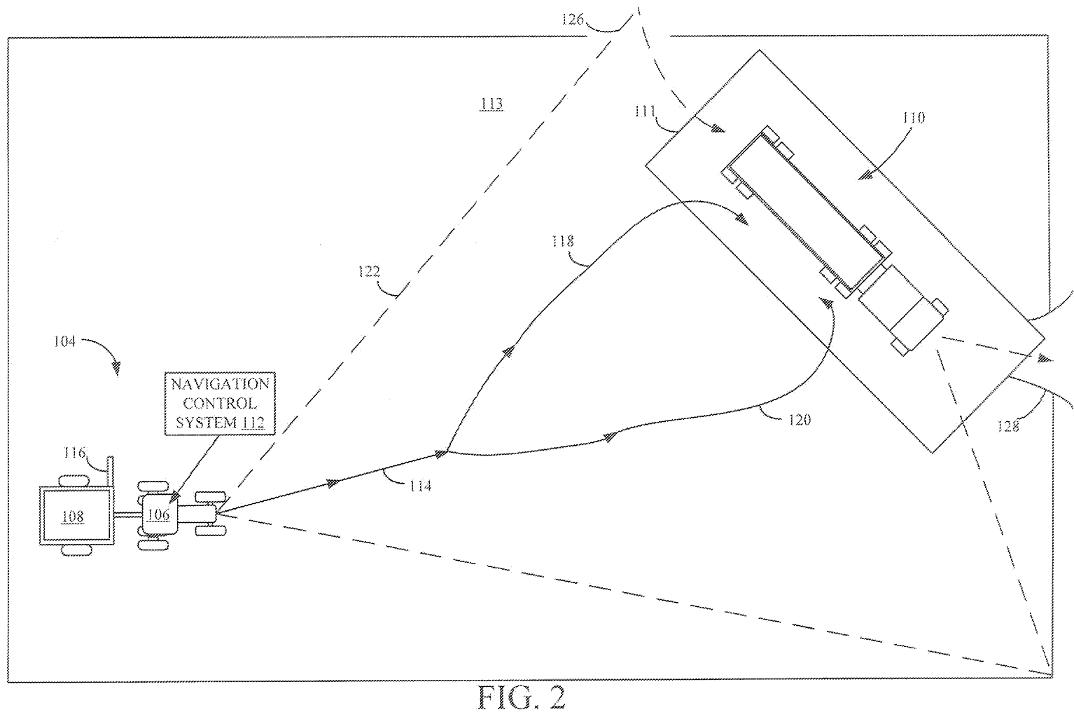

FIG. 2 shows an enlarged portion of FIG. 1, and similar items are similarly numbered. FIG. 2 now shows that the two vehicles 104 and 110 are close enough that the haulage vehicle 110 is within the sensor range 122 of the higher precision sensors on material transfer vehicle 104 so those sensors can now begin sensing haulage vehicle 110. Thus, the more high precision sensors can provide navigation control system 112 with a more precise location and pose of haulage vehicle 110 than the rough location sensors. Therefore, navigation control system 112 can correct the path to follow branch 118 instead of branch 120, based upon the higher precision sensor signals.

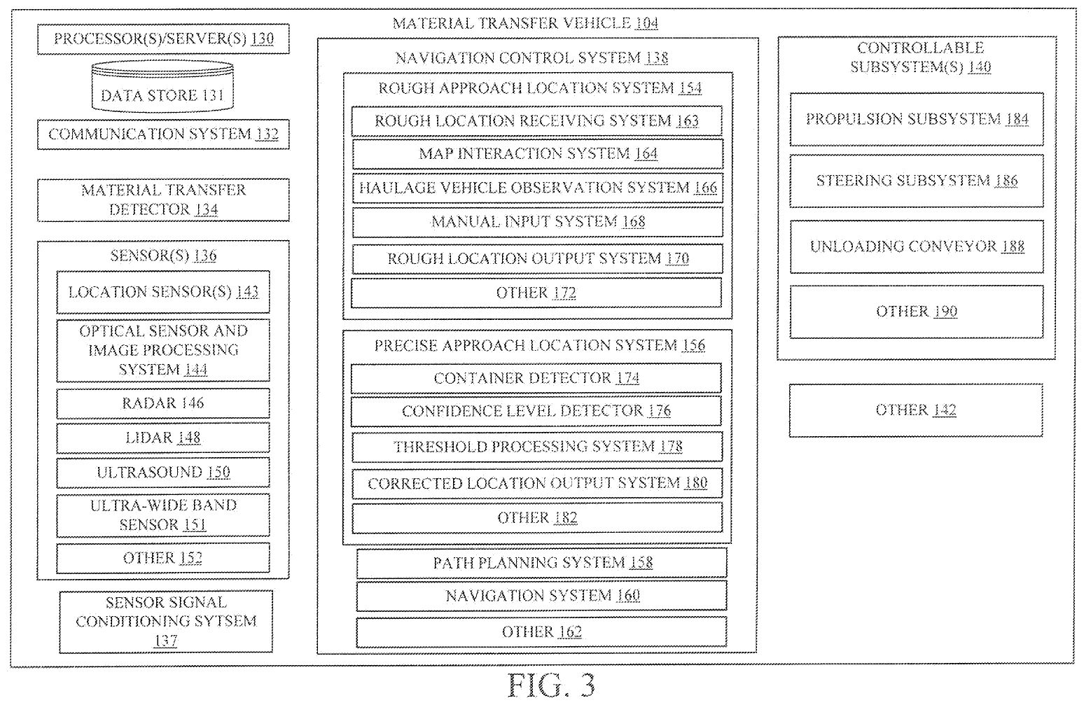

FIG. 3 is a block diagram showing one example of material transfer vehicle 104 in more detail. In the example shown in FIG. 3, material transfer vehicle 104 includes one or more processors or servers 130, data store 131, communication system 132, material transfer detector 134, one or more sensors 136, sensor signal conditioning system 137, navigation control system 138, controllable subsystems 140, and any of a wide variety of other vehicle functionality 142. Sensors 136 can include location sensor 143, an optical sensor with an image processing system 144, RADAR sensor 146, LIDAR sensor 148, ultrasound sensor 150, and/or any of a wide variety of other sensors 152. Navigation control system 138 can include rough approach location system 154, precise approach location system 156, path planning system 158, navigation system 160, and other items 162. Rough approach location system 164 can include rough location receiving system 163, map interaction system 164, haulage vehicle observation system 166, manual input system 168, rough location output system 170, and other items 172. Precise approach location system 156 can include container detector 174, confidence level detector 176, threshold processing system 178, corrected location output system 180, and other items 182. Controllable subsystem 180 can include propulsion subsystem 184, steering subsystem 186, unloading conveyor 188, and any of a wide variety of other controllable subsystems 190. Before describing the operation of material transfer vehicle 104 in more detail, a description of some of the items on material transfer vehicle 104, and their operation, will first be provided.

Communication system 132 illustratively facilitates communication of the items in material transfer vehicle 104 relative to one another and may also facilitate communication of information between vehicles 104 and 110 or to other machines or other systems over different types of networks. Therefore, communication system 132 may include one or more of a controller area network (CAN) bus and bus controller, a cellular communication system, a wide area network and/or a location area network communication system, a Wi-Fi communication system, a Bluetooth or other near field communication system, or any of a wide variety of other communication systems or combinations of communication systems.

Material transfer detector 134 may be a detector that detects a condition indicating that material transfer vehicle 104 should perform a material transfer operation where material is transferred from harvester 102 to haulage vehicle 110. Thus, detector 134 may detect that an unloading operation from harvester 102 to material transfer vehicle 104 has been completed, that grain cart 108 is filled, or any of a variety of other conditions indicating that material transfer vehicle 104 should proceed to haulage vehicle 110 to perform a material transfer or unloading operation.

Location sensor 143 may be a GNSS receiver, a cellular triangulation sensor, a dead reckoning system or any of a variety of other sensors or systems that provide an output indicative of a location of sensor 143 in a global or local coordinate system. Optical sensor and image processing system 144 can include a stereo camera or other optical sensor on material transfer vehicle 104. The optical sensor may have a range or field of view that extends outward relative to material transfer vehicle 104 to capture images in one or more different directions relative to material transfer vehicle 104. The image processing system can process the captured image or images to identify items in those images, such as haulage vehicle 110, etc. The optical sensor may also be able to sense the fill level of material in haulage vehicle 110 or another container or other items. RADAR sensor 146, LIDAR sensor 148 and/or ultrasound sensor 150 may also be disposed on material transfer vehicle 104 to sense items in the proximity of material transfer vehicle 104, such as in sensor range 122 or another sensor range. Sensors 136 may provide sensor signals indicative of the sensed items to sensor signal conditioning system 137. System 137 may perform conditioning on the sensor signals, such as amplification, additional image processing, linearization, normalization, filtering, etc.

Rough approach location system 154 receives a sensor signal or a communication signal or another signal and generates a rough approach location so that path planning system 158 can compute a path to that rough location and so that navigation system 160 can begin controlling controllable subsystems 140 to navigate material transfer vehicle 104 along the computed path. Rough approach location system 154 can detect the rough location in a wide variety of different ways. Rough location receiving system 163 can, for instance, receive the rough location of haulage vehicle 110 (e.g., based on a GNSS receiver on haulage vehicle 110) from communication system 132 or in other ways. The rough location communicated to rough location receiving system 163 may be a rough or relatively imprecise location transmitted by haulage vehicle 110. Map interaction system 164 can interact with a map on which the location of unloading area 111 (or another rough approach location) is marked. By way of example, a user may pull up a mapping system and mark the location of unloading region 111 on the map. Map interaction system 164 can interact with the map to identify that rough location. Haulage vehicle observation system 166 may be a sensor or system that observes where haulage vehicles 110 enter field 113, are loaded, and then exit field 113. Based upon the observed locations, haulage vehicle observation system 166 can generate a rough location. In one example, haulage vehicle observation system 166 can include an unmanned aerial vehicle (UAV) or another optical system that captures images of haulage vehicles 110 as they enter field 113, are loaded, and exit field 113. The images can be correlated to a location by a location system on the UAV, in a remote server environment, or elsewhere, and that location can be transmitted to haulage vehicle observation system 166. Manual input system 168 can be used to manually enter the rough location. For instance, an operator can drive material transfer vehicle 104 to unloading area 111 or to a position within or close to unloading area 111. Once in that position, manual input system, 168 can be used to detect a manual input marking that location as the rough approach location. The rough approach location generated by any of systems 163, 164, 166, and/or 168 may then be provided to rough location output system 170 which outputs the rough approach location (as geographic coordinates within a local or global coordinate system) to path planning system 158. Path planning system 158 then computes a path from a current location of material transfer vehicle 104 (as indicated by location sensor 143) and the rough location output by rough approach location output system 170.

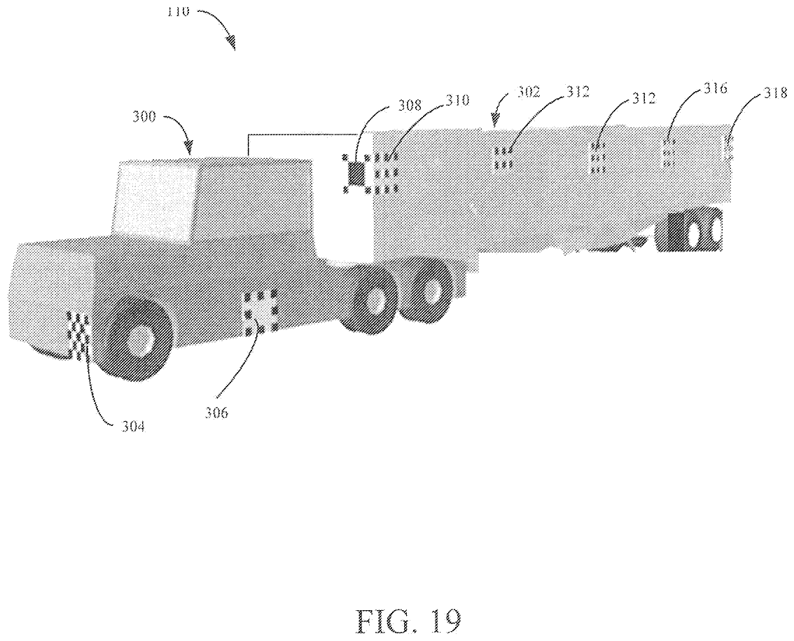

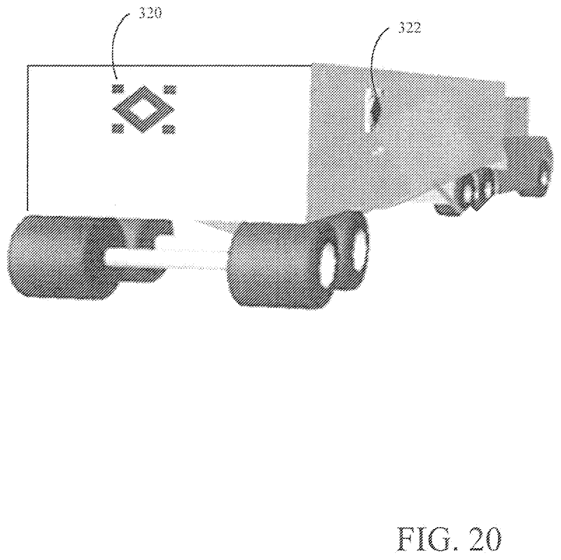

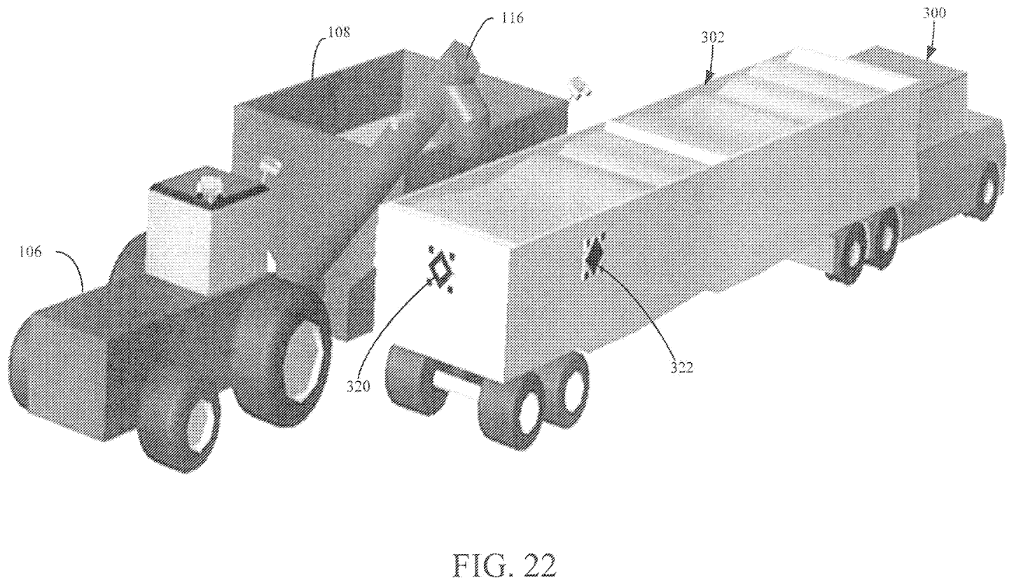

Container detector 174 may receive inputs from sensors 136 or other inputs and detect the container (e.g., in the example being discussed, the container is the semi-trailer of haulage vehicle 110). For instance, based on an output from optical sensor and image processing system 144, container detector 174 may localize the location of haulage vehicle 110 in a local coordinate system (or a global coordinate system). Container detector 174 may also identify the pose or orientation of haulage vehicle 110. In one example, fiducial markers are deployed on haulage vehicle 110 and are detected by an optical sensor 144 to locate haulage vehicle 110. Examples of using fiducial markers are described below with respect to FIGS. 19, 20, 21, and 22. Container detector 174 may alternatively, or in addition, receive a signal from one or more of the other sensors, such as RADAR detector 146, LIDAR detector 148, ultrasound detector 150, ultra-wide band sensor 151 with Bluetooth low energy personal area network system, etc. Based upon the signals from one or more of those detectors, container detector 174 identifies the location and pose or orientation of haulage vehicle 110.

Confidence level detector 176 detects a confidence level corresponding to the location detected by container detector 174. For instance, the sensors 136 may have a range beyond which sensor signals have a low confidence level or are unreliable. However, as the sensors come closer to the sensed item, the confidence level may increase. Thus, confidence level detector 176 may determine the location of haulage vehicle 110 relative to the sensors 136 and determine a confidence level based upon how close the sensors 136 are to the haulage vehicle 110 that is being sensed. In another example, the sensors, themselves, may generate a confidence value indicative of how likely the sensor signal is to be accurate. The confidence level may be generated based upon a signal-to-noise level in the sensor signal, the presence of obscurants that inhibit accurate sensing, and/or in a wide variety of other ways.

Threshold processing system 178 then determines whether the confidence in the location generated by container detector 174 is high enough that the path previously generated by path planning system 158 should be corrected to account for the new, more precise location. For instance, as material transfer vehicle 104 comes into its sensor range of haulage vehicle 110, the precise location of haulage vehicle 110 generated by container detector 174 may not have a high enough confidence level to correct the path computed by path planning system 158 based upon the rough location of haulage vehicle 110. However, as material transfer vehicle 104 comes closer to haulage vehicle 110, then the precise location generated by container detector 174 may have a higher confidence level so that threshold processing system 178 determines that the confidence level passes a threshold confidence level. When that occurs, corrected location output system 180 outputs the more precise location (or corrected location) to path planning system 158. Path planning system 158, in turn, corrects the path that it previously computed and provides the corrected path to navigation system 160. Navigation system 160 then begins controlling controllable subsystems 140 to navigate the material transfer vehicle 104 along the corrected path.

In addition, threshold processing system 178 may determine that a confidence level is so high (e.g., meets an upper confidence level threshold value) that the location can be taken as the final location of haulage vehicle 110, and no further path correction is needed. In that case, navigation system 160 navigates vehicle 104 along the path to complete the unloading application.

Propulsion subsystem 184 can include an engine and one or more transmissions that transmit power to ground engaging elements (such as wheels or tracks) on tractor 106. Propulsion system 184 may also be hydraulic motors, individual motors that drive each of the ground engaging elements, or independent sets of those elements, or another propulsion system. Steering system 186 is controlled to change the direction of movement or heading of material transfer vehicle 104. Therefore, steering subsystem 186 can be a steering wheel and associated components, a set of levers that allow the machine to be controlled in a skid steer fashion, joysticks, or other subsystems that allow the material transfer vehicle 104 to be steered.

Unloading conveyor 188 may be one or more augers (e.g., cross augers and unloading augers, etc.) or other conveyors that convey material out of grain cart 108. In one example, the unloading conveyor 188 may include augers that transmit grain to the inlet end of spout 116 and an additional conveyor or auger that moves the material through spout 116.

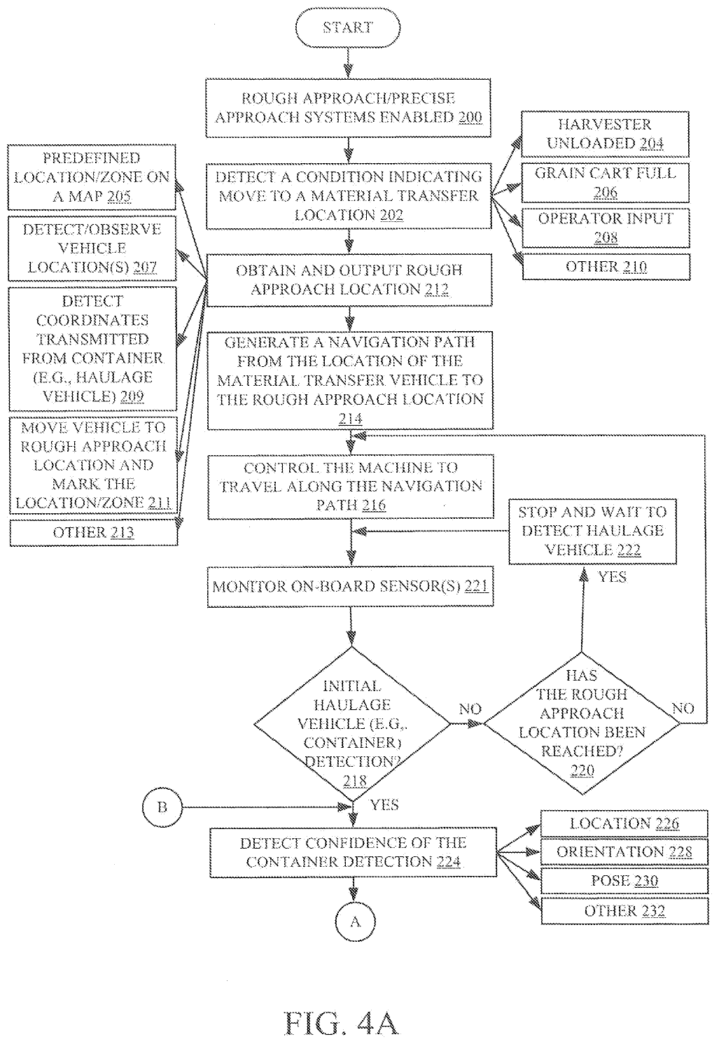

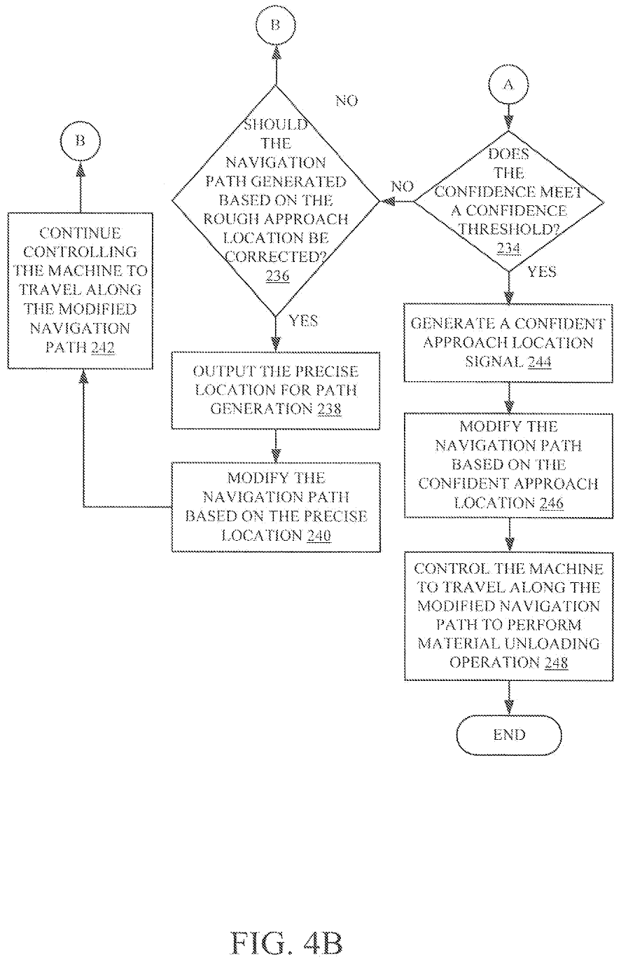

FIGS. 4A and 4B (collectively referred to herein as FIG. 4) show a flow diagram illustrating one example of the operation of material transfer vehicle 104 and navigation control system 138. In the example shown in FIG. 4, it is assumed that the rough approach location system and precise approach location system are enabled so that navigation control system 138 can automatically control material transfer vehicle 104 to approach haulage vehicle 110. Having the rough approach and precise approach systems enabled is indicated by block 200 in the flow diagram of FIG. 4. The system may be enabled by operator input, a remote input, etc.

Material transfer detector 134 then detects a condition indicating that material transfer vehicle 104 should move to a material transfer location for transferring material to a haulage vehicle 110 (or other container). Detecting such a condition is indicated by block 202 in the flow diagram of FIG. 4. The conditions detected by material transfer detector 134 can be any of a wide variety of conditions. For instance, material transfer detector 134 may detect (or receive a message indicating) that the clean grain tank in harvester 102 has been unloaded, as indicated by block 204. Material transfer detector 134 may detect that grain cart 108 is filled to a desired capacity, as indicated by block 206. The material transfer detector 134 may detect an operator input 208 indicating that material transfer vehicle 104 should move to haulage vehicle 110, or another condition 210.

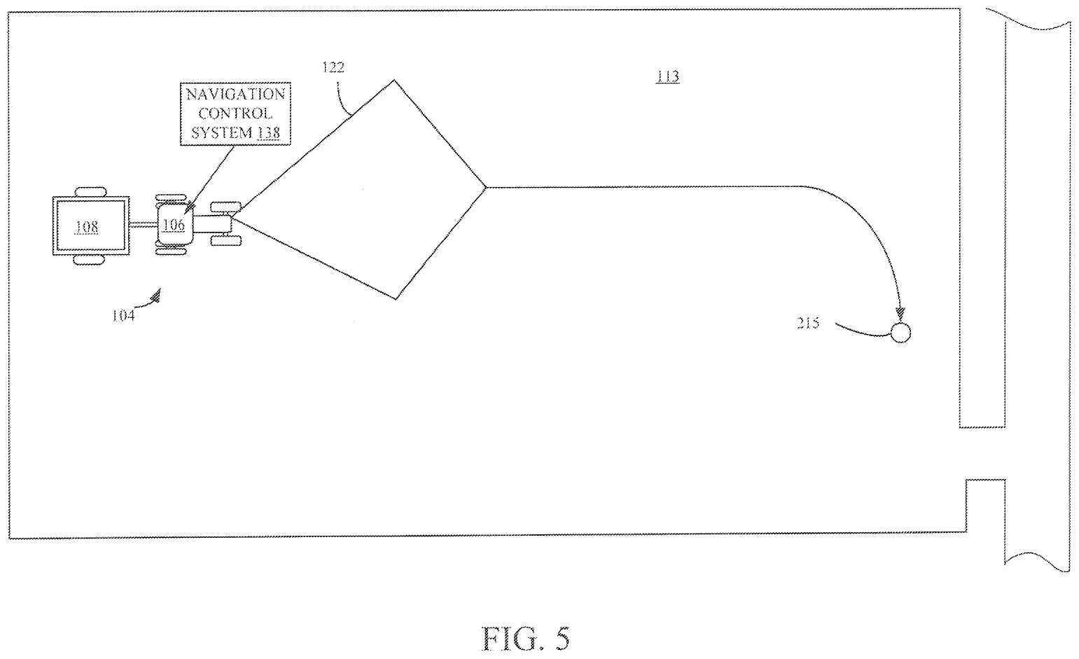

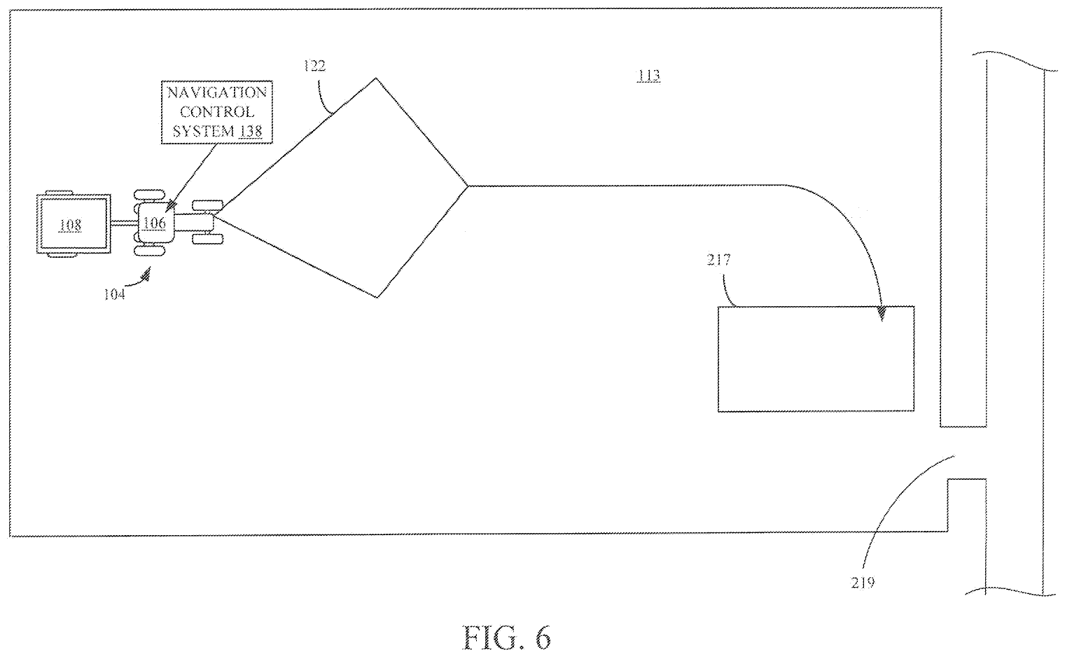

Rough approach location system 154 then detects a rough approach location so that material transfer vehicle 104 can begin traveling to that rough approach location. Obtaining a rough approach location is indicated by block 212 in the flow diagram of FIG. 4. A number of examples are illustrated in FIGS. 5 and 6. FIG. 5 shows an example in which the rough approach location is given by a set of coordinates which identify a location 215 on field 113. Thus, navigation control system 138 begins navigating material transfer vehicle 104 to that rough approach location 215 which may be pre-defined or obtained in another way.

FIG. 6 shows an example in which the rough approach location defines an unloading region or area 217. The unloading area 217 may be pre-defined by an operator based upon an access 219 to field 113 or based on other criteria. Thus, when the rough approach location is provided as an unloading area 217, then navigation control system 138 begins controlling material transfer vehicle 104 to travel along a path so that it arrives at the unloading area 217.

More specifically, and referring again to FIG. 4, map interaction system 164 can detect the rough approach location by accessing a map which has a pre-defined location 215 or zone (e.g., area 217) marked on the map. Accessing a pre-defined location or zone on a map is indicated by block 205 in the flow diagram of FIG. 4. Rough location receiving system 163 can receive a rough location from the haulage vehicle 110, itself. Or, haulage vehicle observation system 166 can receive signals indicative of haulage vehicles 110 having been observed entering and exiting an unloading location (e.g., area 111). Either of these locations can be used as the rough approach location. Detecting or observing the haulage vehicle to obtain the rough approach location is indicated by block 207 in FIG. 4. Detecting coordinates transmitted from the haulage vehicle itself is indicated by block 209 in the flow diagram of FIG. 4. In another example, an operator can move material transfer vehicle 104 to a rough approach location on field 113 and provide a manual input indicating that the current location of material transfer vehicle 104 (after it has been moved to the desired rough approach location) is the rough approach location that should be used by navigation control system 138. Moving material transfer vehicle 104 to the rough approach location and marking that location with a manual or other input as the rough approach location is indicated by block 211 in the flow diagram of FIG. 4.

Rough location output system 170 then outputs the rough location to path planning system 158. Path planning system 158 generates a navigation path leading from the location of the material transfer vehicle 104 to the rough approach location. Generating such a path is indicated by block 214 in the flow diagram of FIG. 4. Navigation system 160 then begins controlling the material transfer vehicle 104 to travel along the navigation path. For instance, navigation system 160 can control controllable subsystems 140 to move material transfer vehicle 104 along the path output by path planning system 158. Navigating vehicle 104 along the path is indicated by block 216 in the flow diagram of FIG. 4.

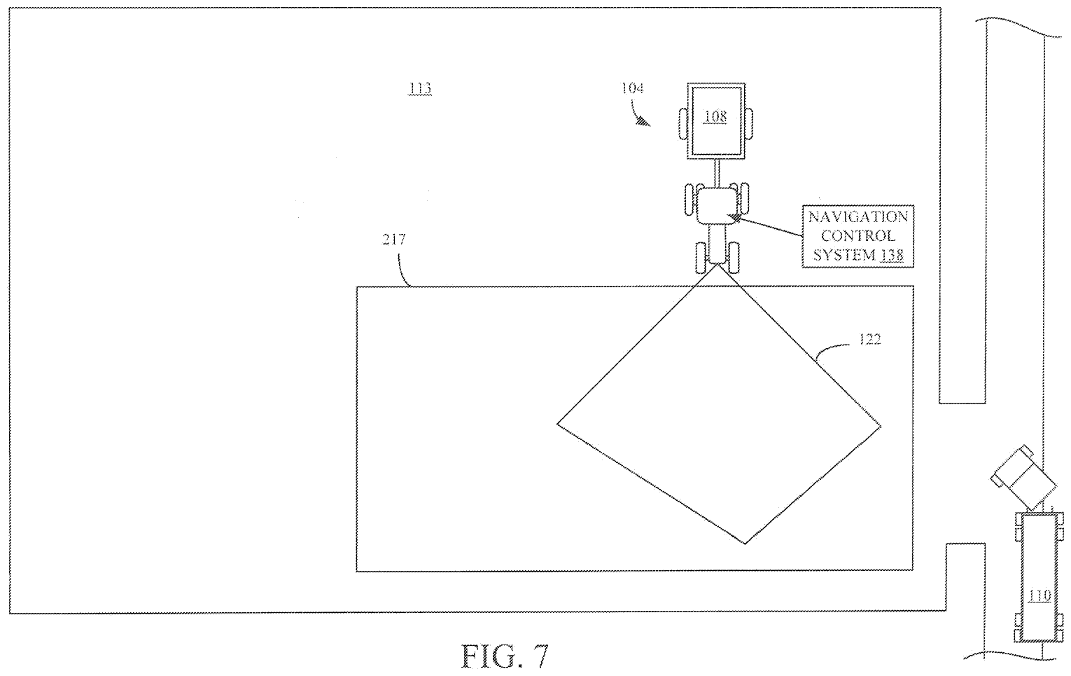

Navigation system 160 continues to navigate material transfer vehicle 104 along the path, while precise approach location system 156 monitors sensors 136 to detect the container, as indicated by block 221 in FIG. 4. Determining whether the haulage vehicle 110 has been initially detected is indicated by block 218 in the flow diagram of FIG. 4. If not, then navigation system 160 determines whether material transfer vehicle 104 has completely traveled the path and reached the rough approach location, as indicated by block 220. If the haulage vehicle 110 has not been detected, nor has vehicle 104 reached the rough approach location, then processing reverts to block 216 where navigation system 160 continues to navigate vehicle 104 along the path toward the rough approach location. However, if, at block 220, vehicle 104 has reached the rough approach location, then navigation system 160 controls vehicle 104 to stop and wait until the haulage vehicle 110 (e.g., the container) has been detected by container detector 174. Stopping and waiting for haulage vehicle detection is indicated by block 222 in the flow diagram of FIG. 4. FIG. 7 illustrates one example.

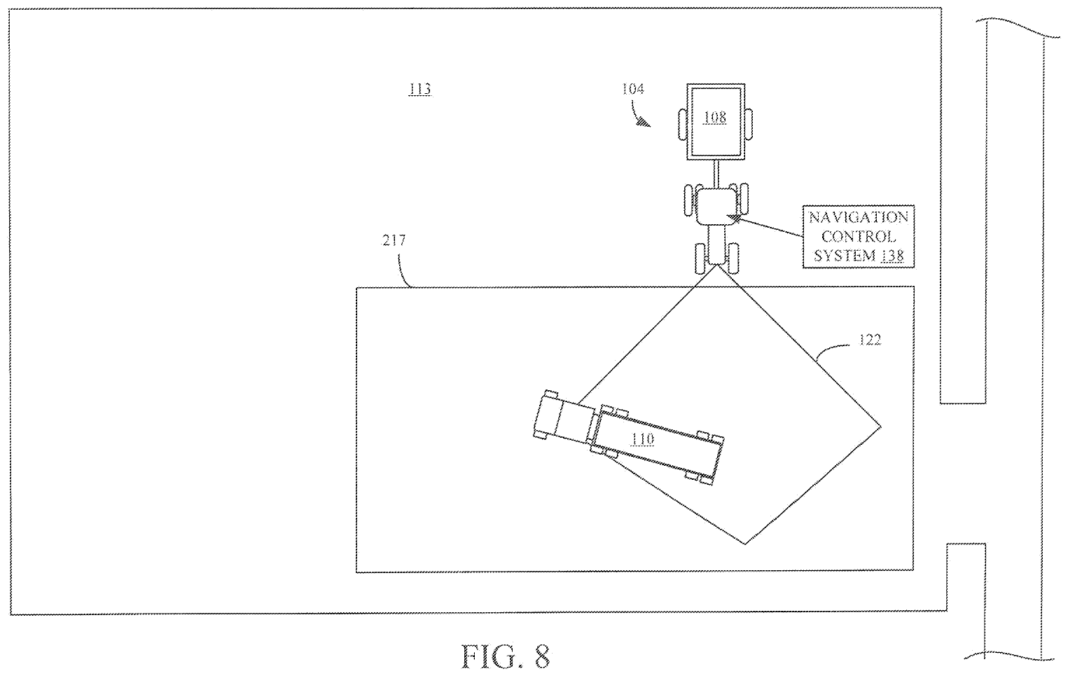

FIG. 7 shows an example in which navigation control system 138 has navigated material transfer vehicle 104 to an unloading area or other rough location 217. At that point, the haulage vehicle 110 has still not arrived so navigation control system 138 controls material transfer vehicle 104 to simply stop and wait until sensors 136 detect the haulage vehicle 110. Then, as soon as haulage vehicle 110 enters the unloading region 217, the haulage vehicle 110 is detected by the sensors 136 on material transfer vehicle 104. An example of this is illustrated in FIG. 8. At that point, the haulage vehicle 110 enters the sensor range 122 of the sensors on material transfer vehicle 104 so that the sensors 136 can sense haulage vehicle 110 and the location of haulage vehicle 110 can be detected by container detector 174.

Referring again to FIG. 4, once the haulage vehicle is detected by container detector 174, confidence level detector 176 computes the confidence of the container detection, as indicated by block 224 in the flow diagram of FIG. 4. The confidence level may indicate how confidence container detector 174 is in generating the location 226, orientation 228, pose 230, or other characteristics 232 of the location of haulage vehicle 110.

Threshold processing system 178 then detects whether the confidence level meets a confidence threshold level, as indicated by block 234.

Threshold processing system 178 may process the detected confidence level with respect to multiple different confidence level thresholds. The confidence threshold value may be empirically set or may be set in a wide variety of other ways.

For example, confidence level detector 176 may compare the confidence level to a first, high, confidence threshold to determine whether the precise location detected by container detector 174 has such high confidence that the location can be used as the final location and no further path corrections are needed. Comparing the confidence level to a first, high threshold is indicated by block 234 in the flow diagram of FIG. 4. If the confidence level does not yet meet the high confidence threshold, then threshold processing system 178 may compare the confidence level to a lower threshold. That comparison may determine whether, even though the precise location does not have a very high confidence level (e.g., it did not meet the high threshold) it may have sufficient confidence that the navigation path should be corrected based on the corresponding location detected by container detector 174. Comparing the confidence level to a second, lower confidence threshold to determine whether the path generated based on the rough approach location should be corrected is indicated by block 236. If the confidence level is so low that no path corrections need to be made, then processing reverts to block 224 where the sensors and container detector 174 continue to detect the location of haulage vehicle 110 and detect the confidence level associated with that detected location to determine whether it meets either of the thresholds.

However, if, at block 236, threshold processing system 178 detects that the path generated based on the rough approach location should be corrected, corrected location output system 180 outputs the precise location generated by container detector 174 to path planning system 158 to correct the navigation path. Outputting the precise location for modified path planning is indicated by block 238 in the flow diagram of FIG. 4. Path planning system 158 then modifies (e.g., corrects) the navigation path based upon the precise location output by corrected location output system 180. Modifying the navigation path is indicated by block 240 in the flow diagram of FIG. 4.

Navigation system 160 then continues to control the material transfer vehicle 104 to travel along the modified navigation path, as indicated by block 242 in the flow diagram of FIG. 4. Processing then reverts to block 224 as the sensors continue to generate signals so that container detector 174 continues to detect the container location and so the confidence level corresponding to the detected container location increases.

If, at block 234, threshold processing system 178 determines that the confidence level corresponding to the location of haulage vehicle 110 is so high that the navigation path no longer needs to be corrected based on future detected locations, then threshold processing system 178 generates a confident approach location signal which is provided, along with the high confidence location, to path planning system 158. Generating a confident approach location signal indicating that the location no longer needs to be corrected is indicated by block 244 in the flow diagram of FIG. 4. Path planning system 158 then modifies the navigation path based upon the confident approach location, as indicated by block 246 and navigation system 160 controls the machine to travel along the modified navigation path to perform the material unloading operation, as indicated by block 248.

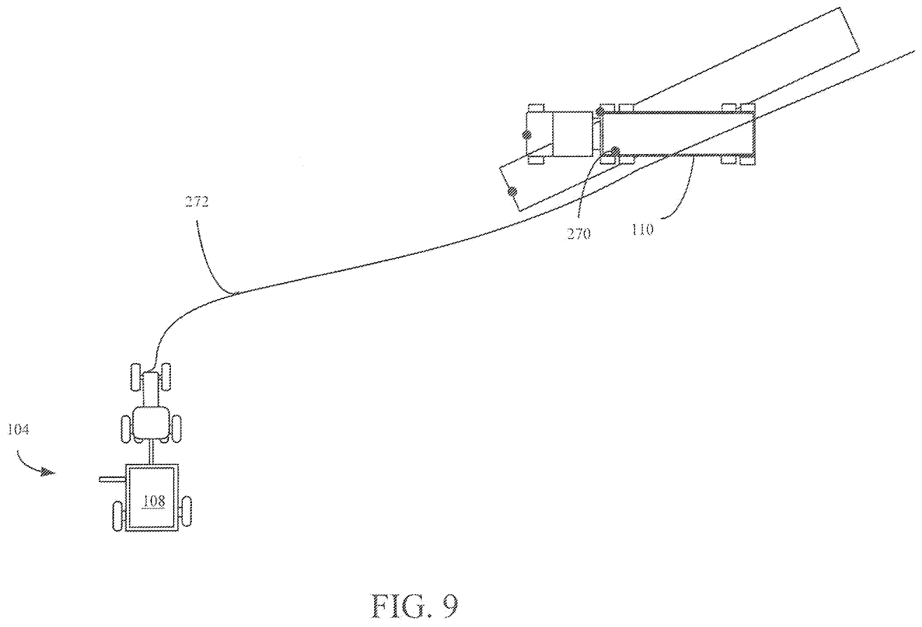

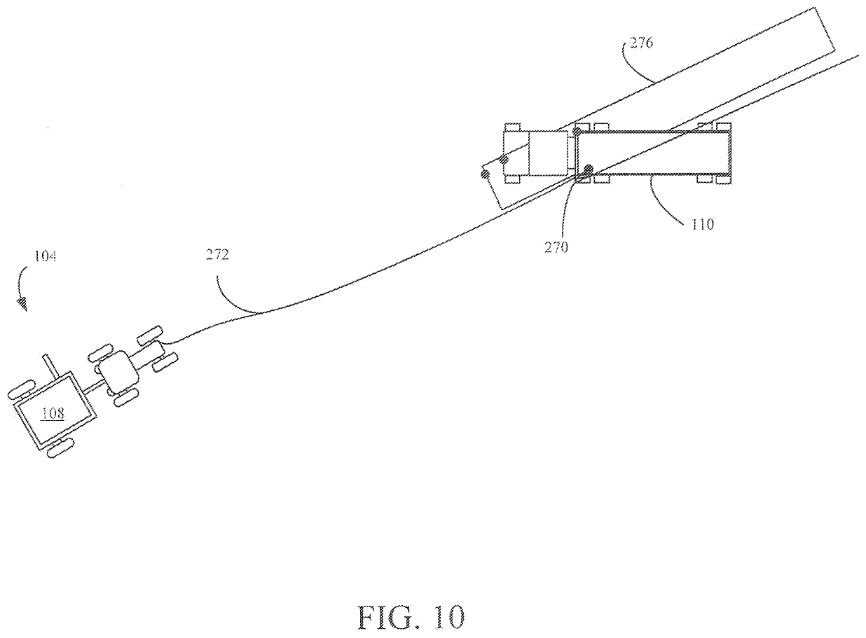

FIGS. 9-18 are pictorial illustrations showing a time-lapsed depiction of the operation of navigation control system 138 and will be described for the purposes of example only. In FIG. 9, it is assumed that sensors 136 include an optical sensor and image processing system 114 for detecting haulage vehicle 110. In FIG. 9, haulage vehicle 110 is still out of the field of view of optical sensor 144. Therefore, the rough location 270 is used for initially navigating along the navigation path 272. In FIG. 10, it is assumed that haulage vehicle 110 has come within the field of view of the optical sensor 144, and that container detector 174 has detected the location of haulage vehicle 110 as illustrated by box 276. However, it is also assumed with respect to FIG. 10 that haulage vehicle 110 is still so far away that the confidence corresponding to the detected location does not meet the minimum confidence level threshold so that the path 272 is not updated and instead navigation continues based upon the path generated for rough approach location 270.

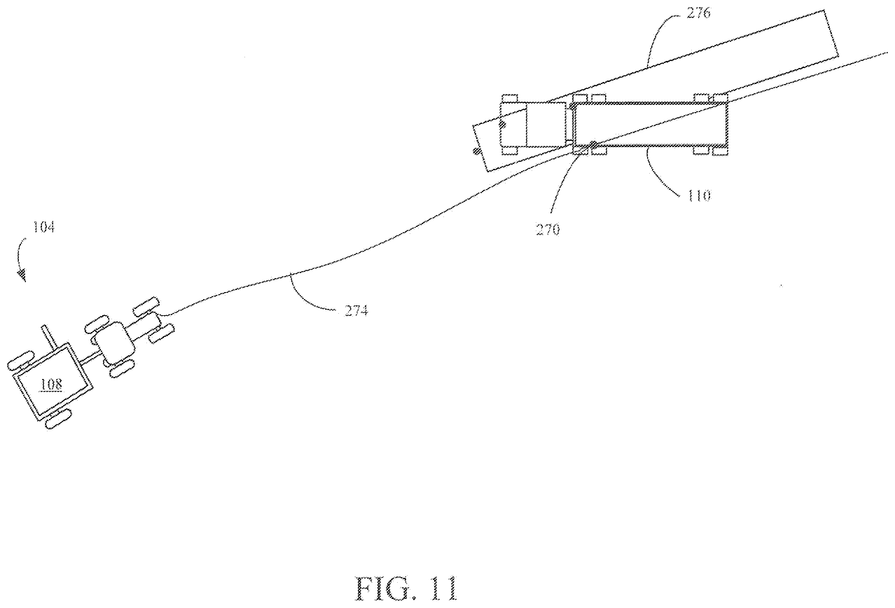

In FIG. 11, material transfer vehicle 104 has come close enough to haulage vehicle 110 that the detected location 276 now has a high enough confidence level to modify the navigation path to path 274, which is slightly corrected relative to path 272 shown in FIG. 10.

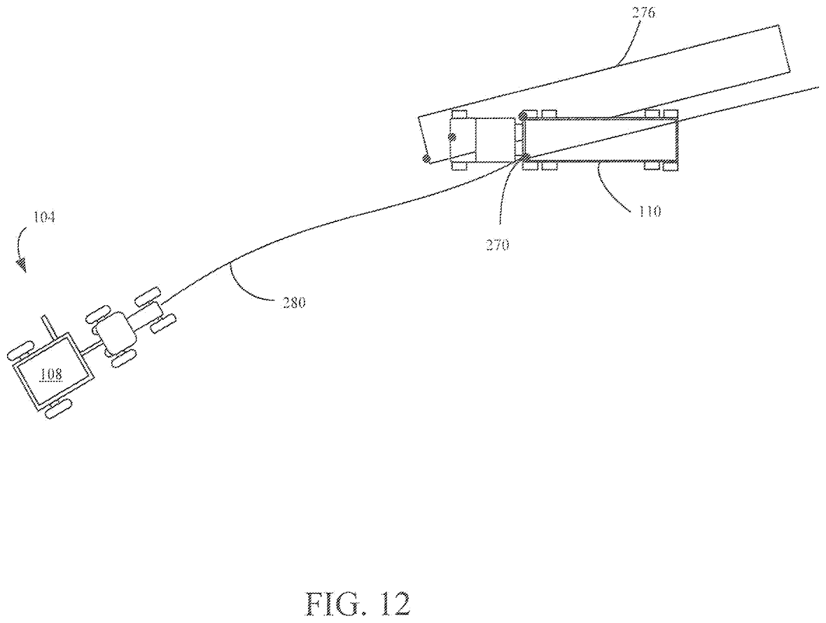

In FIG. 12, it is assumed that material transfer vehicle 104 has come even closer to haulage vehicle 110 so that the sensed position (e.g., location and orientation) 276 of haulage vehicle 110 now more closely matches the actual position (e.g., location and orientation) of haulage vehicle 110. Therefore, the confidence level of the image captured by optical sensor 144 will be higher than that with respect to FIG. 11 and the navigation path will again be corrected to path 280.

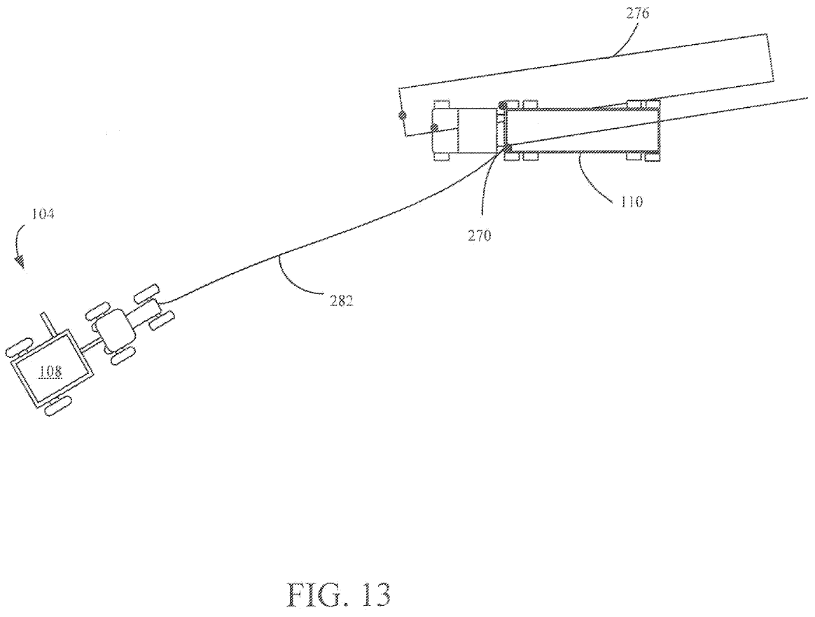

FIG. 13 shows that the image captured by image sensor 144 and the location detected by container detector 174, as indicated by 276 in FIG. 13, now even more closely matches the actual orientation of haulage vehicle 110 than that shown in FIG. 12. Therefore, again, the navigation path is corrected to path 282.

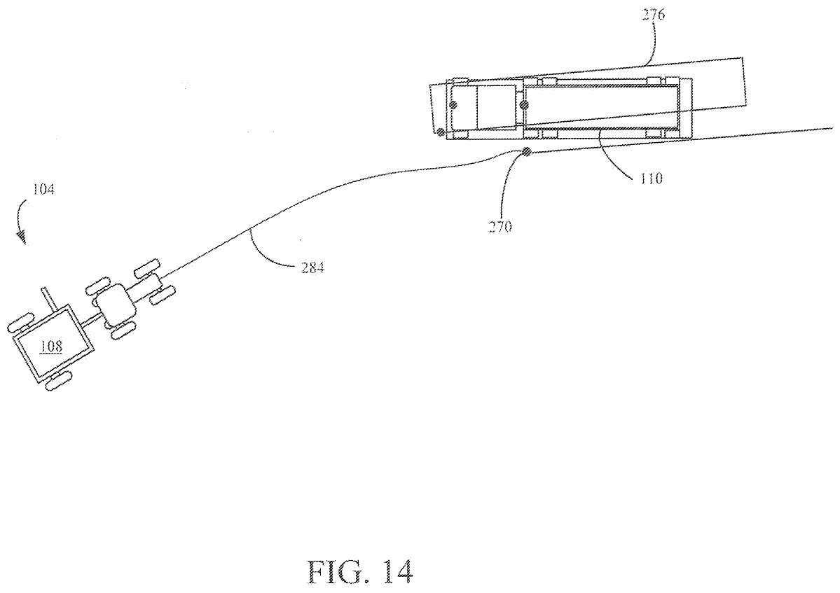

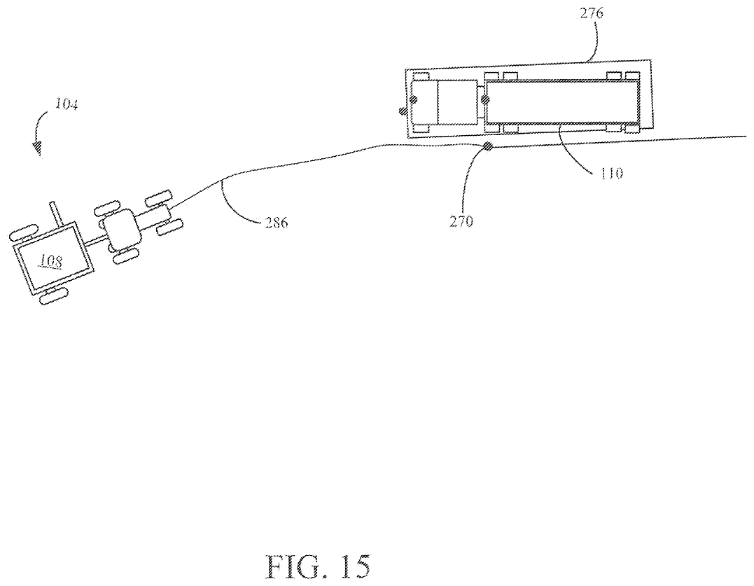

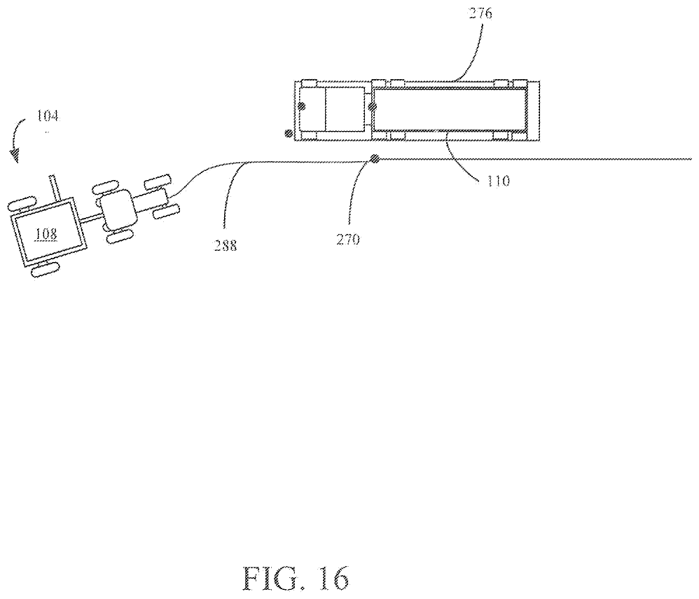

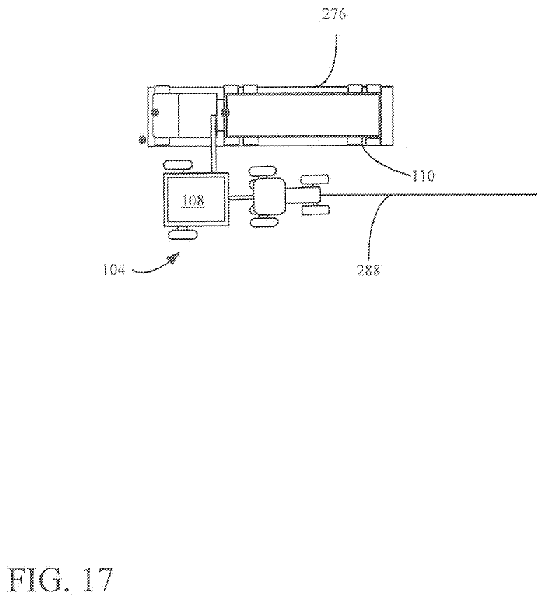

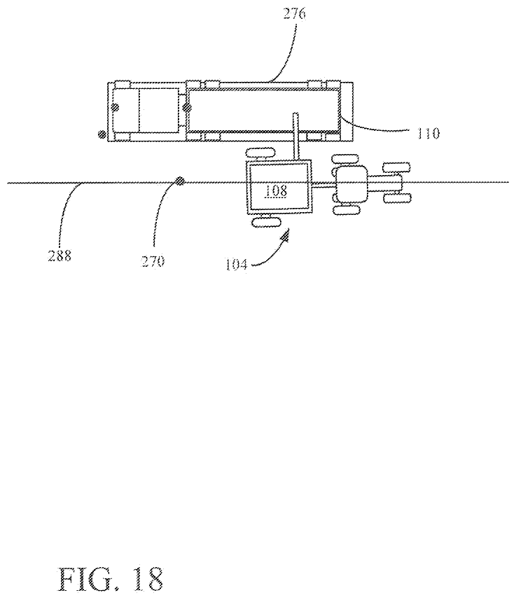

In FIG. 14, as material transfer vehicle 104 comes even closer to haulage vehicle 110, the detected position 276 of haulage vehicle 110 is much more accurate so that the navigation path is now corrected to navigation oath 284. FIG. 15 shows that the detected position 276 of haulage vehicle 110 is even closer to the actual orientation of haulage vehicle 110 so the navigation path is again corrected to navigation path 286. In FIG. 16, the confidence level with respect to the detected position 276 is high enough that the navigation path is corrected to a final navigation path 288 and need no longer be corrected. Instead, as shown in FIGS. 17 and 18, haulage vehicle 104 continues along navigation path 288 until the unloading operation is completed.

As discussed above, precise approach location system 156 can use fiducial markers on the container to identify and localize the container relative to material transfer vehicle 104. As with the previous discussion, in the description relative to FIGS. 19-22, container 110 is identified as a semi-truck 300 pulling a semi-trailer 302. As shown in FIG. 19, fiducial markers can be placed in a wide variety different locations on semi-truck 300 and semi-trailer 302. FIG. 3 shows that a fiducial marker 304 is positioned on the front of semi-truck 300 to identify the front of the truck. Fiducial marker 306 is positioned on the side of the semi-truck 300 to identify the side of the truck.

Semi-trailer 302 has a plurality of different fiducial markers including fiducial marker 308 deployed on the front of the semi-trailer 302 and a plurality of fiducial markers 310, 312, 314, 316, and 318 positioned along the side of semi-trailer 302. The fiducial markers 310-318 can be configured so that fiducial marker 310 can be identified as corresponding to the forward-most end of trailer 304 while fiducial marker 318 identifies the rearward most end of trailer 302. Fiducial markers 312, 314, and 316 can be similarly identified as corresponding to their respective positions along the side of semi-trailer 302. In this way, as material transfer vehicle 104 travels along the side of semi-trailer 302, the fiducial markers can be processed to indicate the position of material transfer vehicle 104 relative to the side of semi-trailer 302. That position can be used by precise approach location system 156 in helping to guide material transfer vehicle 104 along semi-trailer 302.

FIG. 4 also shows that a fiducial marker 320 can be deployed on the rear side of semi-trailer 302 and another fiducial marker 322 can be deployed on the opposite side of trailer 302. In one example, an operator or control system may select a side of trailer 302 along which material transfer vehicle 104 is to travel during an unloading operation. The selected side may be determined based on which side of grain cart 108 the unloading spout 116 is deployed, as well as the fill strategy (e.g., front-to-back, back-to-front, etc.) that is to be used in filling trailer 302. Thus, the fiducial marker 322 may be configured to identify the unselected side of trailer 302 while fiducial markers 310-318 may be configured to identify the selected side of trailer 302. Similarly, fiducial markers 308 and 320 may be configured as corresponding to the front of trailer 302 and the rear of trailer 302, respectively, so that container detector 174 can generate an output indicating whether material transfer vehicle 104 is approaching trailer 302 from the front or the back, and on the selected side or unselected side.

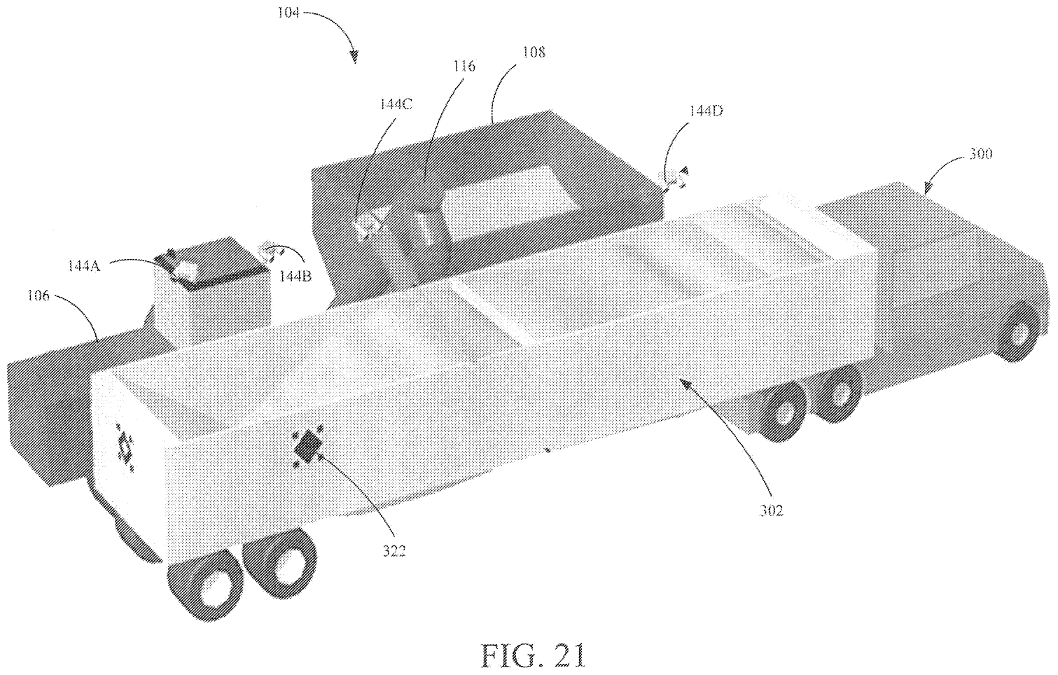

FIG. 21 shows an example in which a plurality of optical sensors 144 are deployed on material transfer vehicle 104. In one example, all of the optical sensors 144A-144D can be used, and in another example a subset of optical sensors 144A-144D can be used. FIG. 21 shows that, in one example, an optical sensor 144A is mounted on a top, forward corner of the operator compartment of tractor 106 while a second optical sensor 144B is deployed on a top rearward corner of the operator compartment of tractor 106. Optical sensor 144C is deployed on unloading spout 116 and optical sensor 144D is deployed on a top rearward corner of grain cart 108. These are only examples of where optical sensors 144 can be mounted.

In one example, optical sensors 144A and 144B may be configured with fields of view that capture not only the side of trailer 302 closest to material transfer vehicle 104, but also the inside of trailer 302. In this way, optical sensors 144A and/or 144B can capture images of the fiducial markers 306-318 as well as the grain inside trailer 302. Thus, trailer 302 can be localized relative to material transfer vehicle 104 using the images of the fiducial markers, and the fill level inside trailer 302 can also be identified or estimated using images of the interior of trailer 302.

Optical sensor 144D may be similar to optical sensors 144A and 144B, in that it captures a field of view that includes the side of trailer 302 and the inside of trailer 302, but it is located on the rear of material transfer vehicle 104. Therefore, the images captured by optical sensor 144D may provide further information indicating the fill level of material inside trailer 302 and the relative position of trailer 302 relative to material transfer vehicle 104. The optical sensor 144C on unloading spout 116 may capture an image of the interior of trailer 302 so that fill level can be estimated based upon such an image.

In another example, the images captured by the different optical sensors 144A-144D may be used for different purposes. The field of view of optical sensor 144A may be more specifically oriented to capture images of the side of trailer 302. In that case, the fiducial markers in those images can be used for automatic steering of material transfer vehicle 104 along the side of trailer 102 during an unloading operation. Other optical sensors 144B, 144C, and 144D may be more specifically oriented to capture images of the interior of trailer 302. Therefore, those images may better be used to estimate the fill level of material inside trailer 302. These are just examples and the images captured by optical sensors 144A-144D can be used in other ways as well.

It will be noted that fiducial markers can be encoded with any of a wide variety of different types of information. That information can include information used to derive the location and orientation of semi-trailer 302 relative to material transfer vehicle 104, information used to detect when material transfer vehicle 104 is approaching the wrong or unselected side of trailer 302, or the wrong or unselected end (front/back) of trailer 302. In one example, an audio and/or visual warning may be sent to an operator who is approaching the non-selected side of trailer 302. Further the fiducial markers can be used to identify a specific trailer 302, a type of trailer 302 (such as a double hopper bottom, a single hopper bottom, etc.) that can be used to determine the type of fill strategy or fill volume or weight that should be used in filling trailer 302, or any of a wide variety of information.

Some examples of fiducial markers include QR codes, two-dimensional bar codes, or other visual tags configured for identification by one or more optical sensors and image processing systems. The fiducial markers can be used to detect any of the walls of trailer 302 and/or the coordinates of the trailer 302 in a local coordinate system.

It can thus be seen that the present system uses a rough approach location (which can be generated using a relatively inexpensive mechanism) to begin navigating the material transfer vehicle 104 toward an unload area or haulage vehicle 110. As the material transfer vehicle 104 gets closer to the haulage vehicle 110, the more precise sensors generate a more precise location of the haulage vehicle 110 so that the navigation path can be corrected based upon that more precise location. In one example, the confidence level is indicative the accuracy or precision of the sensor signals and/or the accuracy or precision of the detected or computed location that is detected or computed based on the sensor signals. The precision of the location increases until its confidence level (or precision) reaches a threshold level at which point no more path corrections need to be made. This increases the accuracy and efficiency of the navigation system, without increasing cost.

The present discussion has mentioned processors and servers. In one example, the processors and servers include computer processors with associated memory and timing circuitry, not separately shown. The processors and servers are functional parts of the systems or devices to which they belong and are activated by, and facilitate the functionality of, the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, sensors, detectors and/or logic. It will be appreciated that such systems, components, sensors, detectors and/or logic can be comprised of hardware items (such as processors and associated memory, or other processing components, some of which are described below) that perform the functions associated with those systems, components, sensors, detectors and/or logic. In addition, the systems, components, sensors, detectors and/or logic can be comprised of software that is loaded into a memory and is subsequently executed by a processor or server, or other computing component, as described below. The systems, components, sensors, detectors and/or logic can also be comprised of different combinations of hardware, software, firmware, etc., some examples of which are described below. These are only some examples of different structures that can be used to form the systems, components, sensors, detectors and/or logic described above. Other structures can be used as well.

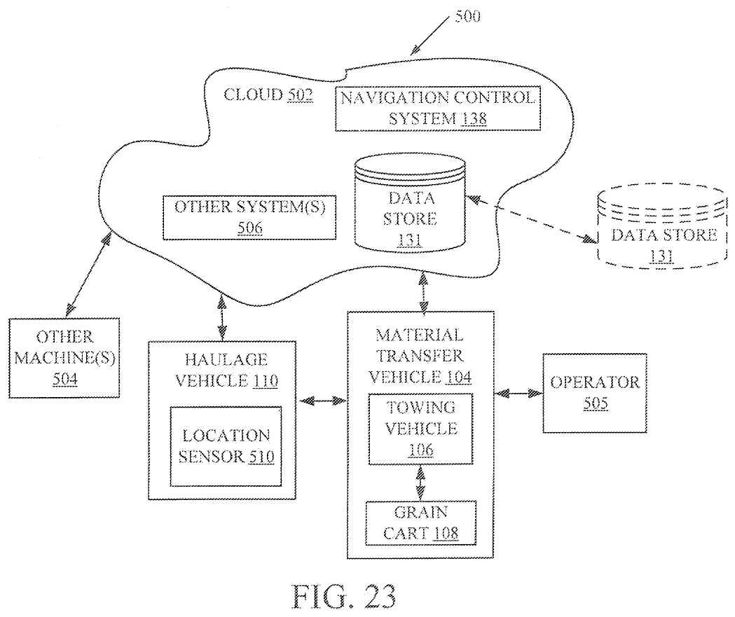

FIG. 23 is a block diagram of agricultural system 100, shown in FIG. 1, except that systems communicate with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in previous FIGS. as well as the corresponding data, can be stored on servers at a remote location. The computing resources in a remote server environment can be consolidated at a remote data center location or the computing resources can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 23, some items are similar to those shown in previous FIGS. and they are similarly numbered. FIG. 23 specifically shows that navigation control system 138 (or parts of it) as well as data store 131 and/or other systems 506 can be located at a remote server location 502. Therefore, vehicle 104 accesses those systems through remote server location 502.

FIG. 23 also depicts another example of a remote server architecture. FIG. 23 shows that it is also contemplated that other machines 504 can communicate through remote server environment 502 and that some elements of previous FIGS are disposed at remote server location 502 while others are not. By way of example, remote data store 131 or other items can be disposed at a location separate from location 502, and accessed through the remote server at location 502. Regardless of where the other items are located, the other items can be accessed directly by system 100, through a network (either a wide area network or a local area network), the items can be hosted at a remote site by a service, or the items can be provided as a service, or accessed by a connection service that resides in a remote location. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

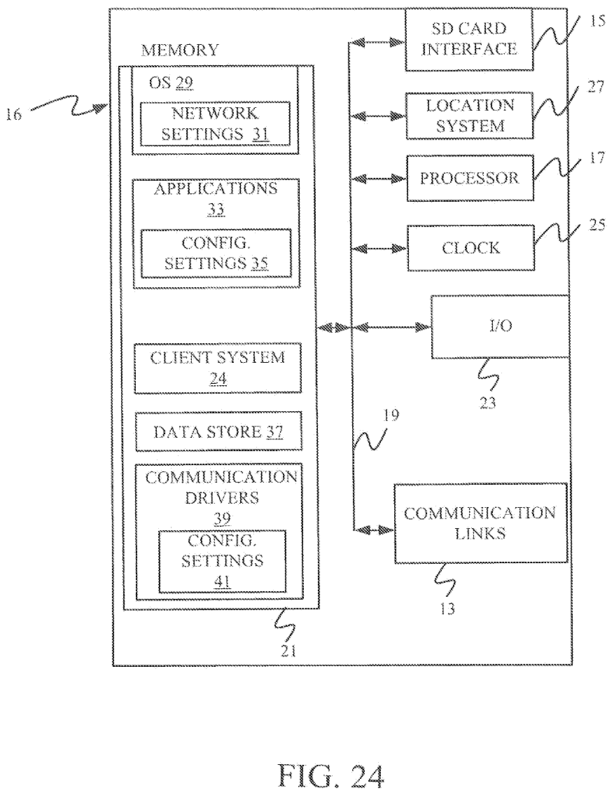

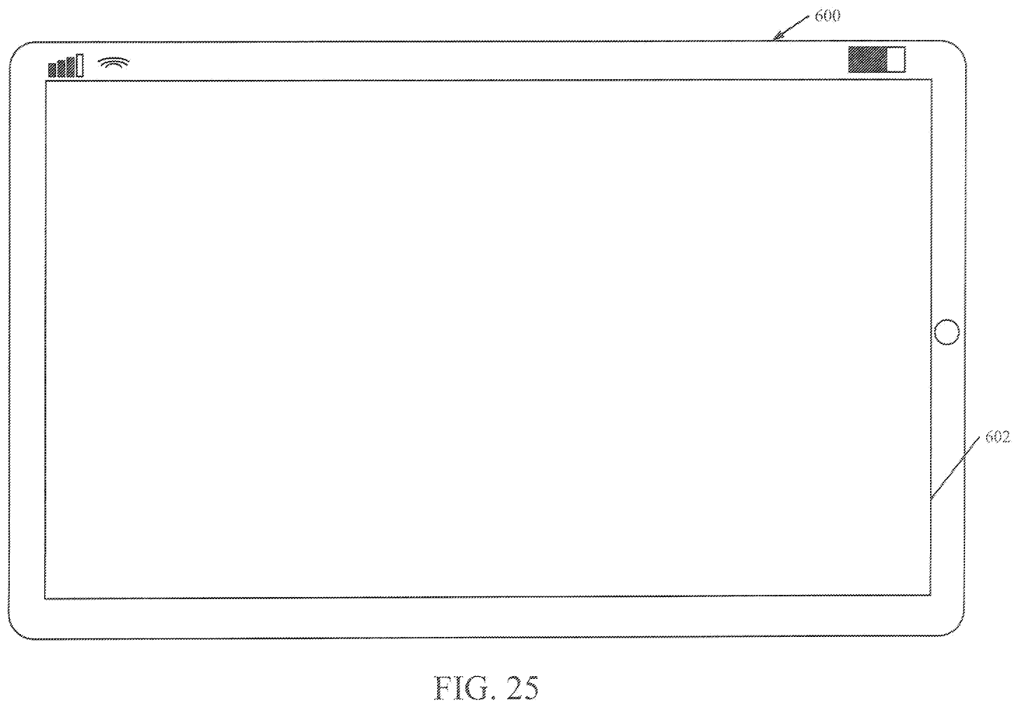

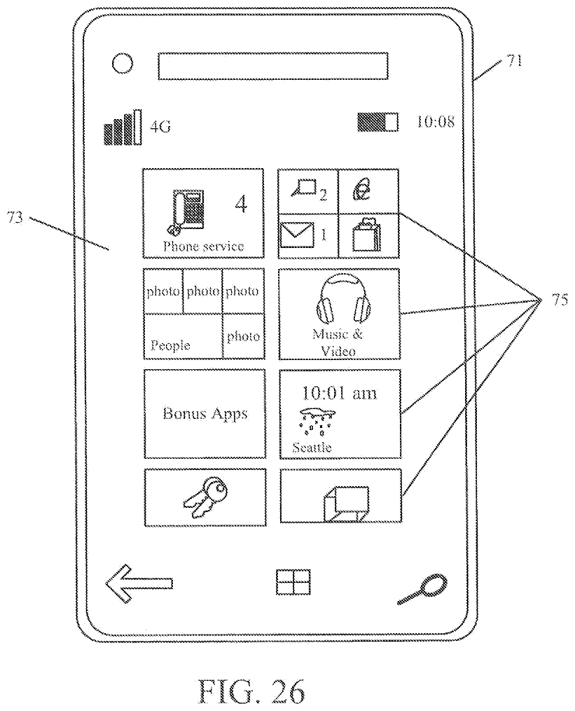

FIG. 24 is a simplified block diagram of one illustrative example of a handheld or mobile computing device that can be used as a user's or client's hand held device 16, in which the present system (or parts of it) can be deployed. For instance, a mobile device can be deployed in the operator compartment of any of the vehicles for use in generating, processing, or displaying the locations, paths, etc. FIGS. 25 and 26 are examples of handheld or mobile devices.

FIG. 24 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 25 shows one example in which device 16 is a tablet computer 600. In FIG. 25, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

FIG. 26 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

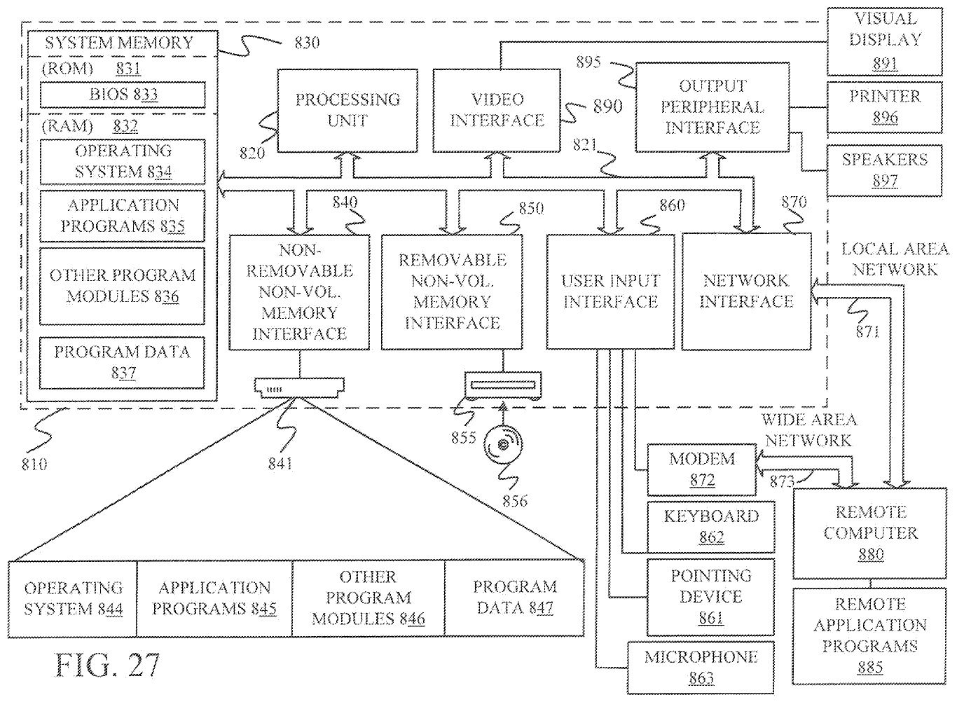

FIG. 27 is one example of a computing environment in which elements of previous FIGS., or parts of it, (for example) can be deployed. With reference to FIG. 27, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 27.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 27 illustrates operating system 834, application programs 835, other program modules 836, and program data 837.

The computer 810 may also include other removable/non-removable volatile/nonvolatile computer storage media. By way of example only, FIG. 27 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 27, provide storage of computer readable instructions, data structures, program modules and other data for the computer 810. In FIG. 27, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network—CAN, local area network—LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 27 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method of controlling a material transfer vehicle in approaching a material container, comprising:
receiving a rough location signal from a first sensor;
identifying a rough approach location based on the rough location signal;
generating a navigation path based on the rough approach location;
controlling the material transfer vehicle to travel along the navigation path toward the rough approach location;
detecting a precise approach location based on a location signal from a second sensor, the location signal from the second sensor being indicative of a sensed location of a material container;
identifying a confidence value corresponding to the precise approach location; and
correcting the navigation path based on the precise approach location and based on the confidence level corresponding to the precise approach location.

2. The computer implemented method of claim 1 wherein correcting the navigation path comprises:
comparing the confidence level to a first threshold confidence level to generate a first comparison result.

3. The computer implemented method of claim 2 wherein correcting the navigation path comprises:
determining whether to correct the navigation path based on the first comparison result.

4. The computer implemented method of claim 3 wherein correcting the navigation path comprises:
if it is determined that the navigation path is to be corrected based on the first comparison result, then correcting the navigation path based on the precise approach location.

5. The computer implemented method of claim 4 wherein correcting the navigation path comprises:
comparing the confidence level to a second threshold confidence level to generate a second comparison result.

6. The computer implemented method of claim 5 wherein correcting the navigation path comprises:
determining whether to continue correcting the navigation path based on the second comparison result.

7. The computer implemented method of claim 6 wherein correcting the navigation path comprises:
if it is determined that the navigation path is to continue to be corrected, then repeating the steps of detecting the precise approach location, and correcting the navigation path based on the precise approach location.

8. The computer implemented method of claim 1 wherein the material container comprises a haulage vehicle and wherein detecting a precise approach location comprises:
controlling the material transfer vehicle to travel along the navigation path to reach the rough approach location;
after reaching the rough approach location, waiting until the haulage vehicle is detected with the second sensor; and
detecting the precise approach location based on the sensor signal from the second sensor.

9. The computer implemented method of claim 1 wherein the first sensor comprises a location sensor on a haulage vehicle and wherein obtaining the rough approach location comprises:
receiving a location signal from the first sensor on the haulage vehicle.

10. The computer implemented method of claim 1 wherein obtaining the rough approach location comprises:
accessing map information from a map; and
identifying, as the rough approach location, an unloading area based on the map information.

11. The computer implemented method of claim 1 wherein obtaining the rough approach location comprises:
navigating the material transfer vehicle to the rough approach location; and
after the material transfer vehicle reaches the rough approach location, detecting an operator input saving a current location of the material transfer vehicle as the rough approach location.

12. An agricultural system, comprising:
a rough approach location system configured to receive a rough location signal from a first sensor system and identify a rough approach location based on the rough location signal;
a path planning system configured to generate a navigation path based on the rough approach location;
a navigation system configured to control the material transfer vehicle to travel along the navigation path toward the rough approach location;
a precise approach location system configured to detect a precise approach location based on a location signal from a second sensor, the location signal from the second sensor being indicative of a sensed location of a material container; and
a confidence level detector configured to identify an accuracy measure indicative of a confidence corresponding to the precise approach location, the path planning system being configured to correct the navigation path based on the precise approach location and based on the accuracy measure.

13. The agricultural system of claim 12 wherein the confidence level detector is configured to compare the confidence level to a first threshold confidence level to generate a first comparison result and determine whether to correct the navigation path based on the first comparison result.

14. The agricultural system of claim 13 wherein the path planning system is configured to correct the navigation path based on the precise approach location when the first comparison result indicates that the accuracy measure meets the first confidence threshold.

15. The agricultural system of claim 12 wherein the material container comprises a haulage vehicle and wherein the navigation system is configured to control the material transfer vehicle to travel along the navigation path to reach the rough approach location and, after reaching the rough approach location, wait until the haulage vehicle is detected with the second sensor wherein the precise approach location is configured to detect the precise approach location based on the sensor signal from the second sensor.

16. The agricultural system of claim 12 wherein the first sensor system comprises a location sensor on a haulage vehicle and wherein the rough approach location system comprises:
a communication system configured to receive a location identifier identifying a location of the haulage vehicle based on a sensor signal from the first sensor system on the haulage vehicle.

17. The agricultural system of claim 12 wherein the first sensor system comprises a map and wherein the rough approach location system comprises:
a map interaction system configured to interact with the map and identify, as the rough approach location, an unloading area based on the map information.

18. A computer system comprising:
at least one processor; and
a data store storing computer executable instructions which, when executed by the at least one processor, cause the at least one processor to perform steps, comprising:
receiving a rough location signal from a first sensor;
identifying a rough approach location based on the rough location signal;
generating a navigation path based on the rough approach location;
controlling the material transfer vehicle to travel along the navigation path toward the rough approach location;
detecting a precise approach location based on a location signal from a second sensor, the location signal from the second sensor being indicative of a sensed location of a material container;
identifying a confidence value corresponding to the precise approach location; and
correcting the navigation path based on the precise approach location and based on the confidence level corresponding to the precise approach location.

19. The computer system of claim 18 wherein correcting the navigation path comprises:
comparing the confidence level to a first threshold confidence level to generate a first comparison result; and
determining whether to correct the navigation path based on the first comparison result.

20. The computer system of claim 18 wherein the material container comprises a haulage vehicle and wherein detecting a precise approach location comprises:
controlling the material transfer vehicle to travel along the navigation path to reach the rough approach location;
after reaching the rough approach location, controlling the material transfer vehicle to wait until the haulage vehicle is detected with the second sensor; and
detecting the precise approach location based on the sensor signal from the second sensor.
